(19) United States
(12) Patent Application Publication
(10) Pub. No.: US 2006/0196969 A1
(43) Pub. Date: Sep. 7, 2006

(54) Extendable sprinkler

(76) Inventors: John DeSantis, Selden, NY (US); James J. Caciolli, Centereach, NY (US)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/368,717

(22) Filed: Mar. 6, 2006

Related U.S. Application Data
(60) Provisional application No. 60/658,555, filed on Mar. 4, 2005.

(51) Int. Cl. B05B 15/10

(52) U.S. Cl. 239/205; 239/204; 239/203

(57) ABSTRACT

An extendable sprinkler having a housing, a first extendable member, a second extendable member and a nozzle is disclosed. The first extendable member is slidably positioned within the housing and is movable from a retracted position to an extended position extending from the housing. The second extendable member is slidably positioned within the first extendable member and is movable from a retracted position to an extended position extending from the first extendable member. The nozzle is supported on one end of the second extendable member such that when the first and second extendable members are in their extended positions, the nozzle is elevated to a height above the housing of between about 1.5 h to about 2 h, wherein h is the height of the housing.

### CROSS-REFERENCE TO RELATED APPLICATIONS

This application claims priority from U.S. Provisional Application Ser. No. 60/658,555, filed Mar. 4, 2006, the entirety of which is incorporated herein by reference.

### BACKGROUND

1. Technical Field

The present disclosure relates to a sprinkler for use in an underground sprinkling system. More specifically, the present disclosure relates to a sprinkler for use in an underground sprinkler system which is extendable from the ground and includes a plurality of stages.

2. Background of Related Art

Extendable sprinklers which are positioned beneath the ground and include a sprinkler head which is moved to an extended position above the ground are well known in the art. Such sprinklers typically include a housing and a telescoping inner member which supports a sprinkler head and is slidably positioned within the housing. When water is supplied to the housing, the force of the water on the telescoping inner member moves the telescoping inner member from a retracted position located within the housing to an extended position extended from the housing.

One problem associated with known extendable sprinklers is that the sprinkler must be buried into the ground to a depth which is substantially equal to the desired height of extension of the sprinkler from the ground. For example, if the desired height of the extended sprinkler is eighteen inches, an eighteen inch hole must be dug into the ground to accommodate the sprinkler. This problem becomes greater as the desired height of extension increases.

Accordingly, a continuing need exists in the sprinkler art for an extendable sprinkler which can reach increased heights of extension without the associated increased difficulties in installing the sprinkler.

### SUMMARY

In accordance with the present disclosure, an extendable sprinkler is disclosed which includes a tubular housing having a first open end and a second open end, a first tubular member slidably positioned within the tubular housing, a second tubular member slidably positioned within the first tubular member, and a nozzle supported on one end of the second tubular member. The first tubular member is movable from a retracted position located within the tubular housing to an extended position extending from the tubular housing. The second tubular member is movable from a retracted position located within the first tubular member to an extended position extending from the first tubular member. When the first and second tubular members are in their extended positions, the nozzle is spaced from the second open end of the housing by a distance d of about 1.5 h to about 2.0 h, wherein h is the height of the housing. In one embodiment, d is about 1.9 h.

In one embodiment, a first biasing member is positioned to urge the first tubular member to its retracted position and a second biasing member is positioned to urge the second tubular member to its retracted position. The first biasing member is positioned between the housing and the first tubular member and the second biasing member is positioned between the first tubular member and the second tubular member. The first and second biasing members can include a coil spring.

In one embodiment, the first open end of the housing includes a threaded bore adapted to engage a fluid supply conduit. In another embodiment, a filter is supported within the second tubular member.

A housing cover can be secured to the second end of the housing. The housing cover defines an opening dimensioned to receive the first tubular member. The housing cover includes screw threads for removably securing the housing cover to the second end of the housing. In addition, a first tubular member cover defining an opening for slidably receiving the second tubular member can be supported on a second end of the first tubular member. The first tubular member cover can be removably secured to the second end of the first tubular member by screw threads. The housing cover and the first tubular member cover are removable to disassemble the components of the sprinkler.

### BRIEF DESCRIPTION OF THE DRAWINGS

Various embodiments of the presently disclosed extendable sprinkler are disclosed herein with reference to the drawings, wherein:

FIG. 1 is a side perspective view from above of one embodiment of the presently disclosed extendable sprinkler in its retracted position;

FIG. 2 is an enlarged cutaway perspective view of an upper end of the extendable sprinkler shown in FIG. 1;

FIG. 3 is a side cross-sectional view of the extendable sprinkler shown in FIG. 1;

FIG. 4 is a side cross-sectional view of the extendable sprinkler shown in FIG. 1 with the second extendable member in the extended position;

FIG. 5 is an enlarged view of the indicated area of detail shown in FIG. 4;

FIG. 6 is a side cross-sectional view of the extendable sprinkler shown in FIG. 4 with the first and second extendable members in their extended positions;

FIG. 7 is an enlarged view of the indicated area of detail shown in FIG. 6; and

FIG. 8 is a side perspective view of the extendable sprinkler shown in FIG. 1 with the first and second extendable members in their extended positions.

### DETAILED DESCRIPTION OF EMBODIMENTS

Embodiments of the presently disclosed extendable sprinkler will now be described in detail with reference to the drawings in which like reference numerals designate corresponding or identical elements in each of the several views.

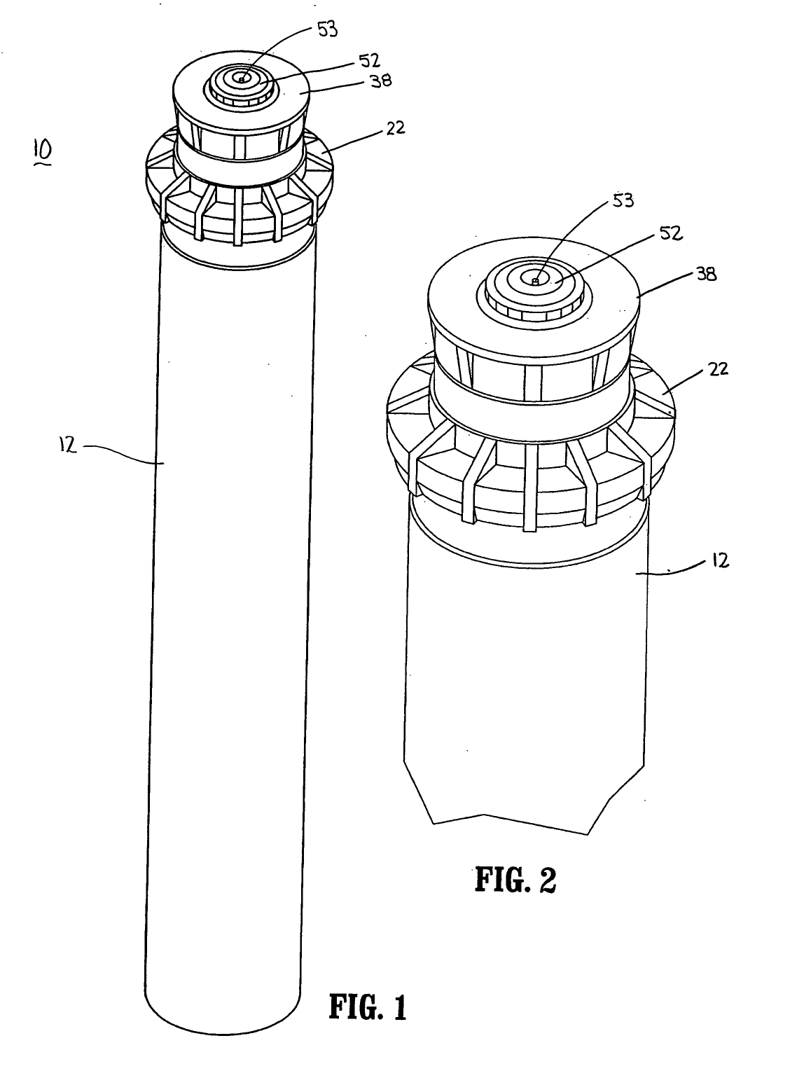

Referring to FIGS. 1-3, the extendable sprinkler, shown generally as 10, includes a housing 12 having a first end 14 adapted to engage a water supply conduit (not shown) and a second open end 16. In one embodiment, first end 14 includes a threaded bore 18 for threadably engaging one end of a supply conduit (not shown). Second open end 16 includes screw threads 20 for engaging a housing cover 22 which includes a central opening 24.

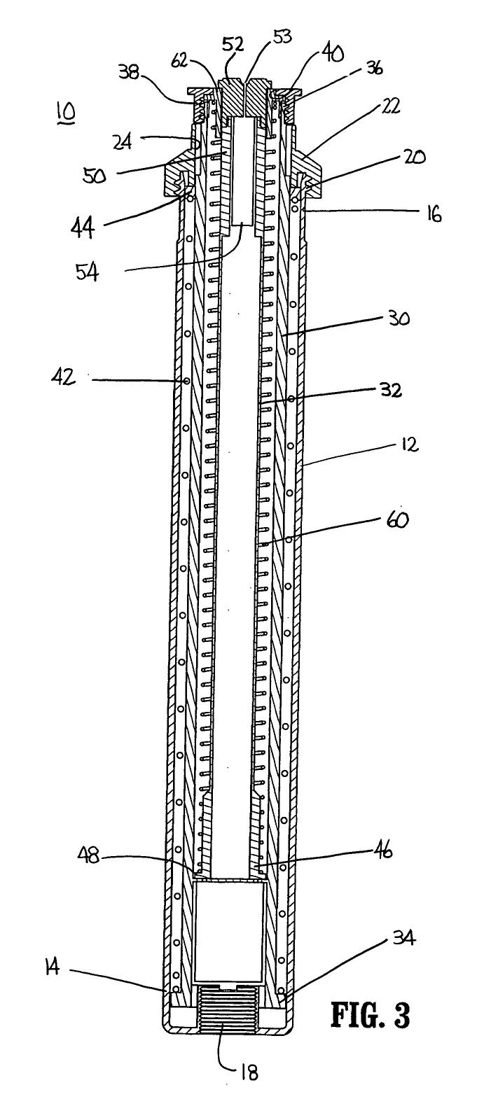

Referring to FIG. 3, extendable sprinkler 10 further includes a first extendable member 30 and a second extendable member 32. First extendable member 30 is preferably tubular and has a first end having an annular flange 34 and a second end including screw threads 36 adapted to releasably engage a second cover 38. Second cover 38 defines an opening 40 for slidably receiving second extendable member 32. A first biasing member, e.g., a coil spring 42, is positioned between housing 12 and first extendable member 30. One end of coil spring 42 engages flange 34 and the other end engages a spring support member 44. Spring support member 44 is positioned between housing cover 22 and biasing member 42 such that biasing member 42 urges first extendable member 30 to a retracted position within housing 12.

Second extendable member 32 is also preferably tubular and is positioned within first extendable member 30. A first end 46 of second extendable member 32 includes a flange 48 and a second end 50 of second extendable member 32 supports a sprinkling device or nozzle 52 defining an orifice 53. Nozzle 52 can be screw threaded onto second end 50 of second extendable member 32. Alternately, other known fastening techniques may be used to secure nozzle 52 to extendable member 32. A filter or strainer 54 may be provided at the inlet to nozzle 52 to prevent clogging of nozzle 52.

A second biasing member, e.g., a coil spring 60, is positioned about second extendable member 32 within first extendable member 30. One end of second biasing member 60 is positioned to engage flange 48 of member 32 and a second end of biasing member 60 is positioned against an annular sealing member 62 supported within opening 40 of second cover 38 such that biasing member 60 urges second extendable member 32 to a retracted position. Annular sealing member 62 is positioned about nozzle 52 to prevent water leakage from between nozzle 52 and second cover 38.

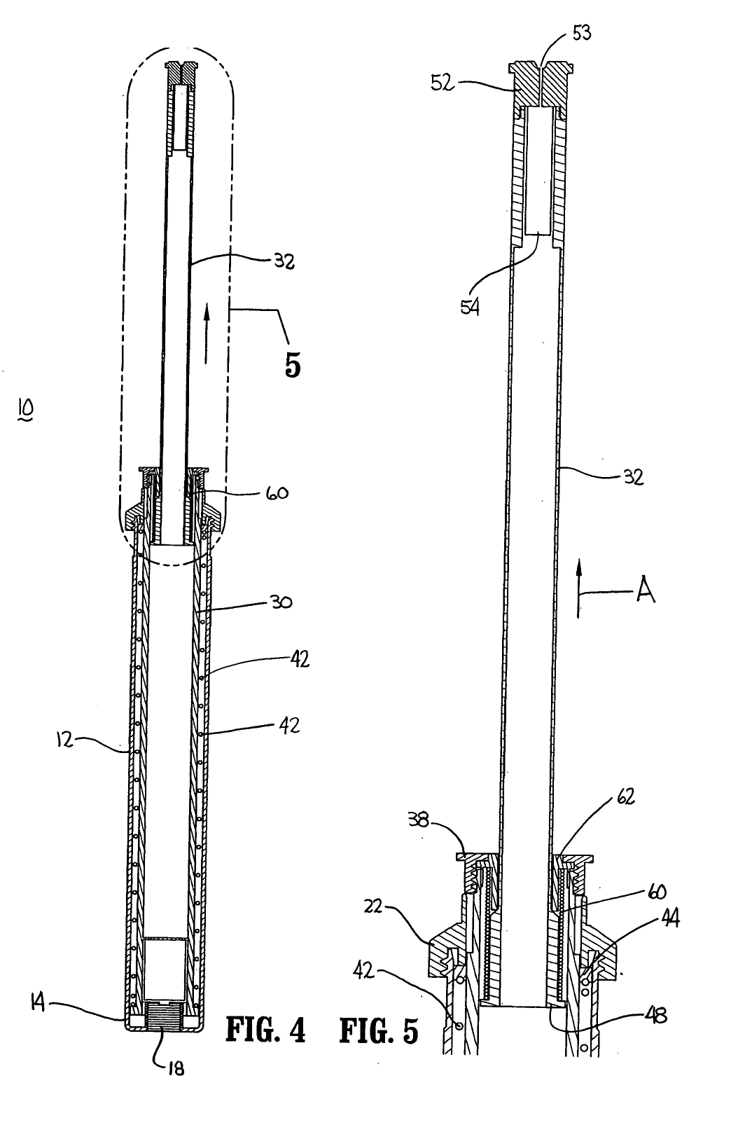

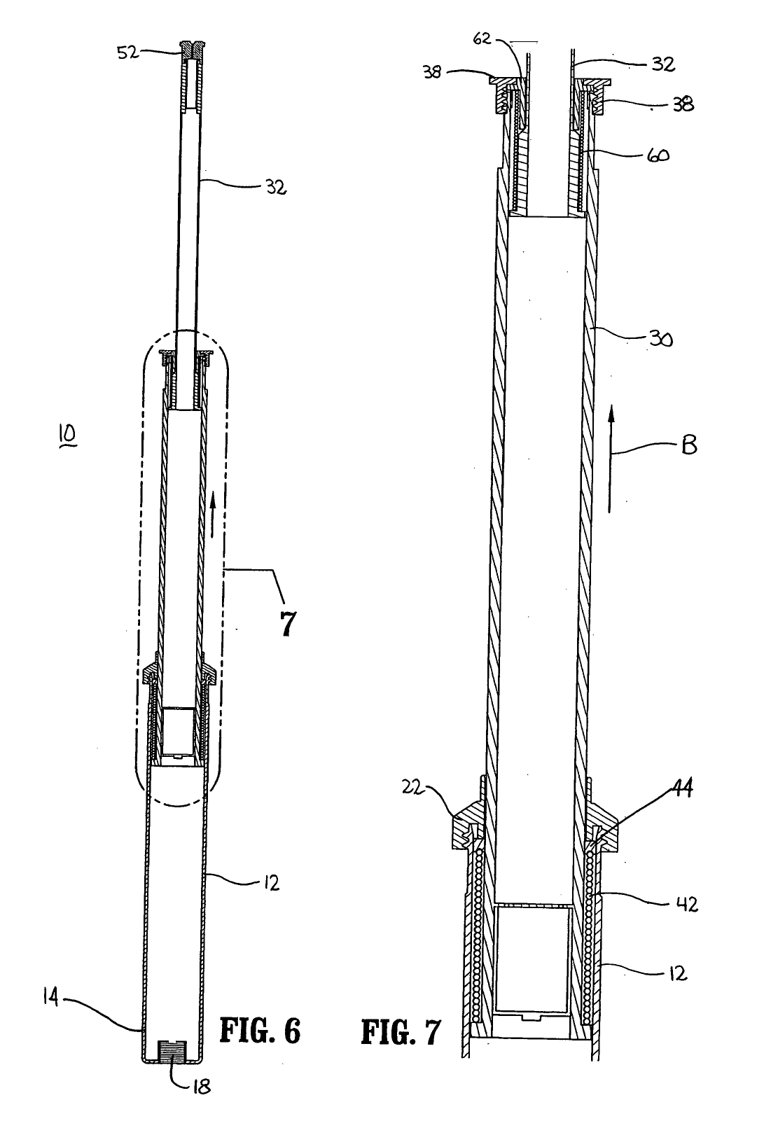

Referring now to FIGS. 4 and 5, when water is supplied to first end 14 of housing 12, the water travels into second extendable member 32 to nozzle 52 and also beneath flange 48 of second extendable member 32 to push second extendable member 32 against the urging of biasing member 60 from its retracted position, in the direction indicated by arrow “A” in FIG. 5, to an extended position. Simultaneously, water flows to a position beneath flange 34 of first extendable member 30 to urge first extendable member 30 towards its extended position. Preferably, biasing members 42 and 60 are selected to allow second extendable member 32 to move to its extended position before first extendable member 30 moves to its extended position.

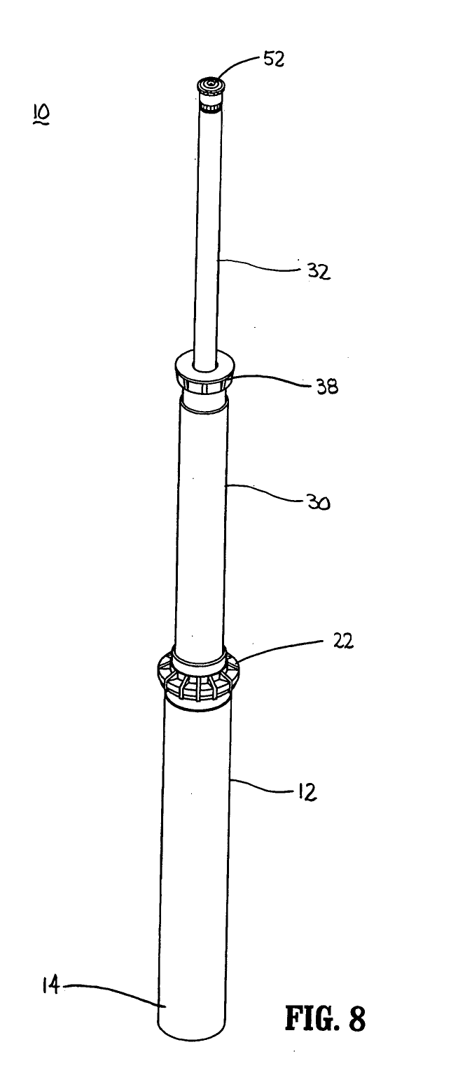

As illustrated in FIG. 5, when second extendable member 32 is in its extended position, the force of water on the second extendable member and the first extendable member moves first extendable member 30 to move first extendable member 30 in the direction indicated by arrow “B” in FIG. 7 from its retracted position to its advanced position. As illustrated in FIG. 8, when the first and second extendable members are in their extended positions, nozzle 62 is extended to a height of substantially twice the height of housing 12. As such, extendable sprinkler 10 need only be buried in the ground a depth which is equal to substantially half the height of the extension of the sprinkler from the ground.

In one embodiment, housing 12 is approximately 17.25 inches in height, first extendable member is approximately 17 inches in height and second extendable member is approximately 15.50 inches in height. In the extended positions of the presently disclosed first and second extendable members, the height of the nozzle is extended to a distance of about 1.9 h from the housing, wherein h is the height of the housing. Preferably, the combined lengths of the first and second extendable members are such that the nozzle is spaced from the housing about 1.5 h to about 2 h when the first and second extendable members are in their extended positions. Alternately, the heights of each of the housing and the first and second extendable members can be increased (or decreased) to increase the extension of nozzle 62 from the ground. Further, it is contemplated that sprinkler 10 can be modified to include three or more extendable members to achieve even greater height extension of nozzle 62 from the housing.

It will be understood that various modifications may be made to the embodiments disclosed herein. For example, although the sprinkling device is illustrated as a nozzle, it is envisioned that other sprinkling devices may also be supported on the second extendable member, e.g., oscillating sprinklers. Further, although the housing and first and second extendabale members are shown as having a circular cross-section, other tubular configurations are envisioned, e.g. rectangular, square, oval, triangular, etc. Therefore, the above description should not be construed as limiting, but merely as exemplifications of embodiments. Those skilled in the art will envision other modifications within the scope and spirit of the claims appended hereto.

What is claimed is:

1. An extendable sprinkler comprising:
a tubular housing having a first open end and a second open end;
a first tubular member slidably positioned within the tubular housing, the first tubular member being movable from a retracted position located within the tubular housing to an extended position extending from the tubular housing;
a second tubular member slidably positioned within the first tubular member, the second tubular member being movable from a retracted position located within the first tubular member to an extended position extending from the first tubular member; and
a nozzle supported on one end of the second tubular member;
wherein the first and second tubular members and dimensioned such that when the first and second tubular members are in their extended positions, the nozzle is spaced from the second open end of the housing by a distance d of at least about 1.5 h to about 2.0 h, wherein h is the height of the tubular housing.

2. An extendable sprinkler according to claim 1, wherein d is about 1.9 h.

3. An extendable sprinkler according to claim 1, further including a first biasing member positioned to urge the first tubular member to its retracted position and a second biasing member positioned to urge the second tubular member to its retracted position.

4. An extendable sprinkler according to claim 3, wherein the first biasing member is positioned between the housing and the first tubular member and the second biasing member is positioned between the first tubular member and the second tubular member.

5. An extendable sprinkler according to claim 4, wherein the first and second biasing members include a coil spring.

6. An extendable sprinkler according to claim 5, wherein the first open end of the housing includes a threaded bore adapted to engage a fluid supply conduit.

7. An extendable sprinkler according to claim 6, further including a filter supported within the second tubular member.

8. An extendable sprinkler according to claim 1, further including a housing cover secured to the second end of the housing, the housing cover defining an opening dimensioned to receive the first tubular member.

9. An extendable sprinkler according to claim 1, wherein the housing cover includes screw threads for removably securing the housing cover to the second end of the housing.

10. An extendable sprinkler according to claim 1, wherein the nozzle is secured to the second tubular member by screw threads.

11. An extendable sprinkler according to claim 9, further including a first tubular member cover supported on a second end of the first tubular member, the first tubular member cover defining an opening for slidably receiving the second tubular member.

12. An extendable sprinkler according to claim 11, wherein the first tubular member cover is removably secured to the second end of the first tubular member by screw threads.
